(19) United States
(12) Patent Application Publication
(10) Pub. No.: US 2026/0046369 A1
(43) Pub. Date: Feb. 12, 2026

(54) IMAGE FORMING APPARATUS AND METHOD OF CONTROLLING IMAGE FORMING APPARATUS

(71) Applicant: CANON KABUSHIKI KAISHA, Tokyo (JP)

(72) Inventors: HIROAKI ISHIDA, Tokyo (JP); MIREI AOYAMA, Chiba (JP); AKIHITO YOKOTE, Chiba (JP); TADASHI FUKUDA, Tokyo (JP); TAKENORI SUEOKA, Ibaraki (JP); SHOHEI OKUMURA, Tokyo (JP); TATSUOMI MURAYAMA, Chiba (JP)

(21) Appl. No.: 19/294,997

(22) Filed: Aug. 8, 2025

(30) Foreign Application Priority Data
Aug. 9, 2024 (JP) 2024-134358

(51) Int. Cl. H04N 1/407; H04N 1/58; H04N 1/60

(52) U.S. Cl. CPC H04N 1/407; H04N 1/58; H04N 1/6005

(57) ABSTRACT

An image forming apparatus includes an image former configured to form an image on a sheet, a conveyance path through which a sheet having a pattern image formed thereon by the image former is to be conveyed, a reading sensor configured to read the sheet having the pattern image formed thereon during conveyance of the sheet through the conveyance path, and a controller configured to suppress image density unevenness in a conveying direction of an image to be formed by the image former, wherein the image density unevenness is suppressed based on a reading result of the pattern image read by the reading sensor and a reading result obtained by reading, by the reading sensor, a plurality of positions in the conveying direction of the sheet conveyed through the conveyance path.

### BACKGROUND

### Field of the Technology

The present disclosure relates to an image forming apparatus, such as a copying machine, a multifunction peripheral, or a printer, and a method of controlling an image forming apparatus.

### Description of the Related Art

For example, an image forming apparatus employing an electrophotographic system performs image formation by scanning a photosensitive drum with laser light. The photosensitive drum is a drum-shaped photosensitive member including a photosensitive layer on its surface. The image forming apparatus uniformly charges the photosensitive layer of the photosensitive drum rotating about a drum shaft, and then irradiates (scans) the photosensitive layer with laser light, to thereby form an electrostatic latent image on the photosensitive layer of the photosensitive drum. The electrostatic latent image is developed by toner to become a toner image, and the toner image is transferred onto a sheet. For example, heat and pressure are applied to the sheet having the toner image transferred thereon so that the toner image melts to be fixed. An image is formed (printed) on the sheet as described above.

Such an image forming apparatus has a possibility of occurrence of charging unevenness at the time of charging the photosensitive drum, exposure unevenness at the time of laser light scanning, development unevenness at the time of development, and the like. Those kinds of unevenness may cause occurrence of image density unevenness in a predetermined direction of an image formed on the sheet. For example, the image density unevenness occurs in a main scanning direction and a sub-scanning direction. The main scanning direction is a direction in which the laser light scans the photosensitive drum, and corresponds to a drum shaft direction. The sub-scanning direction is a direction intersecting with the main scanning direction, and corresponds to a rotation direction of the photosensitive drum.

In order to correct the image density unevenness, there is used a sheet in which an image forming range is divided into a plurality of regions, and a measurement image including a pattern image for measuring the image density unevenness is formed in each region. The image density unevenness is corrected by adjusting a laser light amount so that an image density difference between the regions is eliminated, based on measurement results of the pattern images of the respective regions. For example, in U.S. Pat. No. 7,609,909, there is proposed a technology of correcting the image density unevenness in the main scanning direction. In Japanese Patent Application Laid-open No. 2000-98675 and Japanese Patent Application Laid-open No. 2022-71704, there is proposed a technology of correcting the image density unevenness in the sub-scanning direction.

In U.S. Pat. No. 7,609,909, the image density unevenness in the main scanning direction is corrected based on measurement results of the plurality of pattern images arranged side by side in the main scanning direction. In Japanese Patent Application Laid-open No. 2000-98675, the image density unevenness in the sub-scanning direction caused in a rotation period of a developing sleeve is corrected. The developing sleeve is a member that is rotated in association with the rotation of the photosensitive drum to cause toner to adhere to the electrostatic latent image. In Japanese Patent Application Laid-open No. 2022-71704, the image density unevenness in the sub-scanning direction is corrected based on measurement results of a period and an amplitude of the image density unevenness in the sub-scanning direction.

At the time of correcting the image density unevenness as described above, a test chart in which a measurement image for use in detecting the image density unevenness is printed on a sheet is used. The measurement image of the test chart is read by a reading sensor such as an inline sensor provided in the apparatus or a scanner accompanying the apparatus. Such a reading sensor is an optical sensor for reading the measurement image by receiving reflected light of light applied to the test chart.

The reading sensor may cause a reading error depending on light amount unevenness of light applied to the measurement image of the test chart, an individual difference in sensitivity of a reading element, and the like. Further, for example, a reading sensor for reading a measurement image while conveying a test chart sheet causes a reading error due to an unstable reading distance caused by fluttering of the test chart at the time of sheet conveyance. Those reading errors inhibit accurate measurement of the image density unevenness, and hence it becomes difficult to accurately correct the image density unevenness.

### SUMMARY

An image forming apparatus according to one embodiment of the present disclosure includes an image former configured to form an image on a sheet, a conveyance path through which a sheet having a pattern image formed thereon by the image former is to be conveyed, a reading sensor configured to read the sheet having the pattern image formed thereon during conveyance of the sheet through the conveyance path, and a controller configured to suppress image density unevenness in a conveying direction of an image to be formed by the image former, wherein the image density unevenness is suppressed based on a reading result of the pattern image read by the reading sensor and a reading result obtained by reading, by the reading sensor, a plurality of positions in the conveying direction of the sheet conveyed through the conveyance path in a region in which the pattern image is not formed in the sheet having the pattern image formed thereon.

An image forming apparatus according to another embodiment of the present disclosure includes an image former configured to form an image on a sheet, a conveyance path through which a sheet having a pattern image formed thereon by the image former is to be conveyed, a reading sensor configured to read the sheet having the pattern image formed thereon during conveyance of the sheet through the conveyance path, and a controller configured to suppress image density unevenness in a conveying direction of an image to be formed by the image former, wherein the image density unevenness is suppressed based on a result of the pattern image read by the reading sensor and a reading result obtained by reading, by the reading sensor, a plurality of positions in the conveying direction of the sheet conveyed through the conveyance path in a region in which the pattern image is not formed in the sheet having the pattern image formed thereon, wherein the controller is configured to correct, based on a difference between an average value of reading results of the region at respective positions in the conveying direction, which are obtained as a result of two-dimensional linear interpolation of reading results of the region at a plurality of positions in the conveying direction, and a reading result of the region at each position, a reading result of the pattern image at the each position, and suppress the image density unevenness in the conveying direction and in a direction intersecting with the conveying direction based on a corrected reading result of the pattern image.

A method of controlling an image forming apparatus according to yet another embodiment of the present disclosure includes the image forming apparatus including, an image former configured to form an image on a sheet, a conveyance path through which a sheet having a pattern image formed thereon by the image former is to be conveyed, and a reading sensor configured to read the sheet having the pattern image formed thereon during conveyance of the sheet through the conveyance path, the method comprising suppressing, based on a reading result of the pattern image read by the reading sensor and a reading result obtained by reading, by the reading sensor, a plurality of positions in a conveying direction of the sheet conveyed through the conveyance path in a region in which the pattern image is not formed in the sheet having the pattern image formed thereon, image density unevenness in the conveying direction of an image to be formed by the image former.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration view for illustrating an image forming apparatus.

FIG. 2 is a configuration explanatory view for illustrating an image forming unit.

FIG. 3 is a flow chart for illustrating processing of correcting image density unevenness in a sub-scanning direction.

FIG. 4 is an exemplary view for illustrating a sub-scanning measurement image.

FIG. 5 is an explanatory view for illustrating a detection position of the sub-scanning measurement image.

FIG. 6 is an exemplary graph for illustrating a luminance value of a magenta pattern image.

FIG. 7 is an exemplary graph for illustrating a luminance difference of a bare surface part.

FIG. 8 is an exemplary graph for illustrating a corrected luminance value.

FIG. 9 is an exemplary graph for illustrating an image density value.

FIG. 10 is an exemplary graph for illustrating a luminance-density conversion table.

FIG. 11 is a flow chart for illustrating processing of correcting image density unevenness in a main scanning direction.

FIG. 12 is an exemplary view for illustrating a main-scanning measurement image.

FIG. 13 is an explanatory view for illustrating a detection position of the main-scanning measurement image.

FIG. 14 is an exemplary graph for illustrating luminance values of first to third bare surface parts.

FIG. 15 is an exemplary diagram for illustrating a luminance value.

FIG. 16 is an exemplary table for illustrating a coefficient.

FIG. 17 is an exemplary graph for illustrating an image density value.

### DESCRIPTION OF THE EMBODIMENTS

### First Embodiment

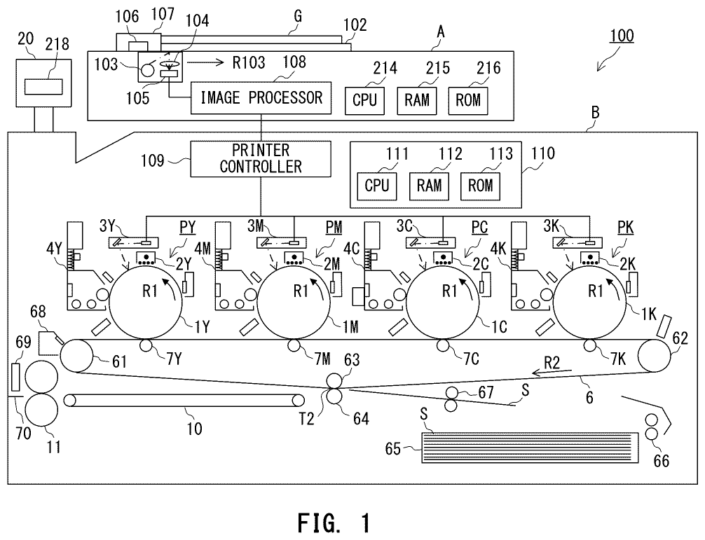

FIG. 1 is a configuration view for illustrating an image forming apparatus of a first embodiment of the present disclosure. An image forming apparatus 100 includes a reader A, a printer B, and an operation unit 20. The printer B prints an image on a sheet S. The reader A reads an image from a sheet (original G) having an image printed thereon. The operation unit 20 is a user interface. The operation unit 20 includes various key buttons or a touch panel as an input interface. The operation unit 20 includes a display unit 218 as an output interface. A user uses the operation unit 20 to give an instruction to start copying or perform various settings.

### <Reader>

The reader A includes a platen 102 for placing the original G thereon, a light source 103 for irradiating the original G placed on the platen 102 with light, an optical system 104, a light receiver 105, and an image processor 108. The reader A further includes a central processing unit (CPU) 214, a random access memory (RAM) 215, and a read only memory (ROM) 216. The light source 103, the optical system 104, and the light receiver 105 form an image reading unit for reading an image of the original G. A positioning member 107 and a reference white plate 106 are arranged at an edge portion of the platen 102. The positioning member 107 allows one side of the original G to be brought into abutment thereagainst to prevent oblique arrangement of the original G. The reference white plate 106 is to be used for shading correction of the image reading unit.

The optical system 104 controls reflected light, which is the light applied from the light source 103 and reflected on the original G, to be imaged on a reading face of the light receiver 105. The light receiver 105 includes a photoelectric conversion element such as a charge coupled device (CCD) sensor, and outputs an image signal obtained by converting the received reflected light into an electric signal. The light receiver 105 includes, for example, photoelectric conversion elements arranged in three rows so as to correspond to red (R), green (G), and blue (B). The light receiver 105 generates color component signals of respective colors including R, G, and B as image signals. The image reading unit reads lines of the image on the original G placed on the platen 102 one after another while moving in an arrow direction R103. Accordingly, the image signals include data columns of the respective lines.

The image signals generated in the light receiver 105 are input to the image processor 108. The image processor 108 performs image processing such as A/D conversion, shading correction, and color conversion on the image signals acquired from the light receiver 105. The image processor 108 transmits the image signals having been subjected to the image processing to the printer B.

The CPU 214 executes a computer program stored in the ROM 216 to control the operation of the reader A. The RAM 215 is a work memory used when the CPU 214 executes the processing. The reader A is controlled by the CPU 214 to perform various operations for reading the image of the original G.

### <Printer>

The printer B includes image forming units PY, PM, PC, and PK, which serve as image formers, an intermediate transfer belt 6, a secondary transfer roller 64, a fixing device 11, a sheet feeding cassette 65, and a printer controller 109. The printer B is a full-color printer of a tandem intermediate transfer type in which the image forming units PY, PM, PC, and PK are arranged along the intermediate transfer belt 6. The image forming unit PY forms a yellow image (toner image). The image forming unit PM forms a magenta image (toner image). The image forming unit PC forms a cyan image (toner image). The image forming unit PK forms a black image (toner image).

The intermediate transfer belt 6 is a belt member wrapped around and supported by a tension roller 61, a drive roller 62, and an opposing roller 63. A belt cleaner 68 is provided so as to be opposed to the tension roller 61. The intermediate transfer belt 6 is driven by the drive roller 62 to rotate in an arrow R2 direction at a predetermined process speed. The images (toner images) respectively formed by the image forming units PY, PM, PC, and PK are sequentially superimposed and transferred onto the intermediate transfer belt 6 at timings set in accordance with a rotation speed of the intermediate transfer belt 6. In this manner, a full-color image (toner image) is formed on the intermediate transfer belt 6. The intermediate transfer belt 6 functions as an intermediate transfer member onto which a toner image is to be transferred.

The opposing roller 63 forms a secondary transfer portion T2 between the opposing roller 63 and the secondary transfer roller 64. The images of the respective colors having been transferred onto the intermediate transfer belt 6 are conveyed to the secondary transfer portion T2 and collectively transferred onto the sheet S. Through application of a DC voltage having a positive polarity to the secondary transfer roller 64, the images (toner images) of the respective colors charged to a negative polarity and borne on the intermediate transfer belt 6 are collectively transferred onto the sheet S. A developer (transfer residual toner) that remains on the intermediate transfer belt 6 after the transfer is removed by the belt cleaner 68. The belt cleaner 68 rubs a cleaning blade against the intermediate transfer belt 6 to collect transfer residual toner remaining on the intermediate transfer belt 6 after passing through the secondary transfer portion T2.

Sheets S are stored in the sheet feeding cassette 65 and fed one after another. On a conveyance path for conveying the sheets S, separation rollers 66 and registration rollers 67 are provided. The sheets S are fed from the sheet feeding cassette 65, separated into individual sheets by the separation rollers 66, and conveyed to the registration rollers 67. The registration rollers 67 receive the sheet S in a stopping state and allow the sheet S to stand by. The registration rollers 67 then convey the sheet S to the secondary transfer portion T2 in accordance with a timing at which the image borne on the intermediate transfer belt 6 is conveyed to the secondary transfer portion T2. The registration rollers 67 function as conveyance unit for conveying the sheet S.

The sheet S having the image transferred thereto is conveyed by the secondary transfer roller 64 to the fixing device 11 via a conveyance belt 10. The fixing device 11 applies heat and pressure to the sheet S so that the image melts to be fixed to the sheet S. The sheet S having the image fixed thereto is discharged to an outside of a machine body of the printer B via a conveyance path 70.

In the conveyance path 70 for use in conveying the sheet S from the fixing device 11 to the outside of the machine body, an image density sensor 69 is arranged as a reading sensor for reading an image printed on the sheet S. The image density sensor 69 is an inline sensor to be used to measure an image density of a pattern image for detecting image density unevenness.

Image formation performed by the image forming units PY, PM, PC, and PK is described. The image forming units PY, PM, PC, and PK are different only in color of the developer (here, which is toner) to be used for development, and perform the same operation with the same configuration. In the following description, letters Y, M, C, and K are added to ends of the reference symbols when the colors are distinguished, and the letters Y, M, C, and K at the ends of the reference symbols are omitted when the colors are not distinguished.

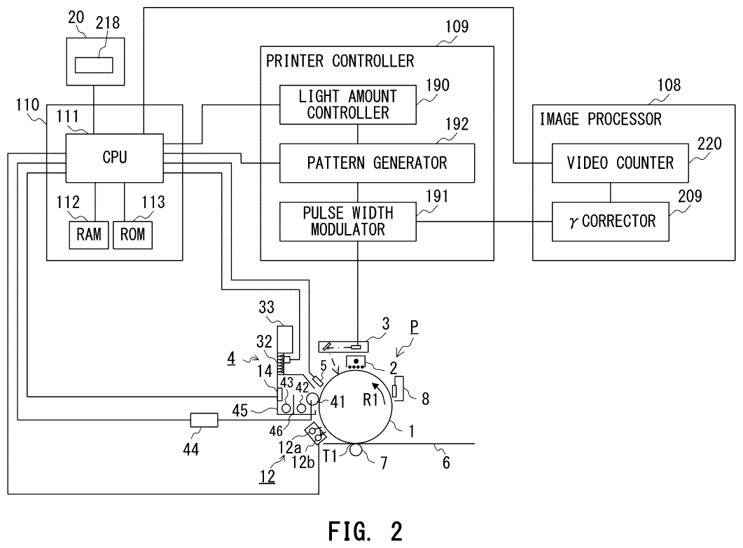

FIG. 2 is a configuration explanatory view for illustrating an image forming unit P. The image forming unit P includes a photosensitive drum 1, a charging device 2, an exposing device 3, a developing device 4, a reflected light amount sensor 12, a primary transfer roller 7, and a drum cleaner 8. The intermediate transfer belt 6 is sandwiched between the photosensitive drum 1 and the primary transfer roller 7. The charging device 2, the exposing device 3, the developing device 4, the reflected light amount sensor 12, the primary transfer roller 7, and the drum cleaner 8 are arranged around the photosensitive drum 1.

The photosensitive drum 1 in the first embodiment is a photosensitive member having a photosensitive layer formed on an outer peripheral surface (surface) of an aluminum cylinder. The photosensitive drum 1 rotates in an arrow R1 direction about a drum shaft at a predetermined process speed. The photosensitive drum 1 is, for example, an organic photo conductor (OPC) photosensitive member having a reflectance of about 40% with respect to near-infrared light (960 nm). The photosensitive drum 1 may be, for example, an amorphous-silicon-based photosensitive member having substantially the same reflectance.

The charging device 2 in the first embodiment is a scorotron charging device, which irradiates the photosensitive drum 1 with charged particles generated by corona discharge to charge the photosensitive layer on the surface of the photosensitive drum 1 to a uniform negative electric potential. The scorotron charging device includes a wire to which a high voltage is to be applied, a grounded shield portion, and a grid portion to which a desired voltage is to be applied. A predetermined charging bias voltage is applied to the wire of the charging device 2 from a charging bias power source (not shown). A predetermined grid bias voltage is applied to the grid portion of the charging device 2 from a grid bias power source (not shown). Although it depends on the voltage applied to the wire, the photosensitive drum 1 is charged substantially to the voltage applied to the grid portion.

The exposing device 3 scans the surface of the charged photosensitive drum 1 in a drum shaft direction by reflecting laser light emitted from a light source with a rotary mirror, to thereby form an electrostatic latent image on the surface of the photosensitive drum 1. Accordingly, the drum shaft direction of the photosensitive drum 1 corresponds to the main scanning direction. The sub-scanning direction intersecting with the main scanning direction corresponds to the rotation direction of the photosensitive drum 1. The sub-scanning direction is also a direction parallel to a conveying direction in which the sheet S is conveyed. In the vicinity of the photosensitive drum 1, a potential sensor 5 serving as a potential detector is provided. The potential sensor 5 can detect the potential of the electrostatic latent image formed on the photosensitive drum 1.

Through application of a development bias voltage to the developing device 4, the developing device 4 causes toner to adhere to the electrostatic latent image on the photosensitive drum 1, thereby forming an image (toner image) on the photosensitive drum 1. The developing device 4 includes, in a developer container 45 for storing the toner, a developing sleeve 41, a first conveyance screw 42, and a second conveyance screw 43. The developer container 45 in the first embodiment stores a two-component developer in which non-magnetic toner and magnetic carriers are mixed. The developer container 45 is divided into two chambers by a partition wall 46. The first conveyance screw 42 is provided in one chamber, and the second conveyance screw 43 is provided in the other chamber. The partition wall 46 has openings formed at two portions, and mutual inflow of the toner is allowed between the two chambers through the openings. The first conveyance screw 42 and the second conveyance screw 43 rotate to cause the developer to circulate in the developer container 45 while being stirred and mixed.

The developing sleeve 41 is arranged close to the photosensitive drum 1, and is rotated in association with the photosensitive drum 1. The developing sleeve 41 carries the developer in which the toner and the carriers are mixed. The developer carried by the developing sleeve 41 develops the electrostatic latent image on the photosensitive drum 1 through application of the development bias voltage to the developing sleeve 41. The development bias voltage is applied by a power supply unit 44. The power supply unit 44 is controlled by a controller 110 (CPU 111) to be described later to control the application of the development bias voltage.

The developing device 4 includes a toner amount sensor 14 for measuring the toner amount in the developer container 45. For example, a magnetic permeability sensor for detecting the magnetic permeability of the developer is used as the toner amount sensor 14. The developing device 4 is connected to a toner replenishment container 33 through a replenishment passage 32. In a case where a measurement result of the toner amount obtained by the toner amount sensor 14 is smaller than a predetermined amount, the toner is supplied from the toner replenishment container 33 to the developer container 45 via the replenishment passage 32.

The reflected light amount sensor 12 is an optical sensor including a light emitter 12a and a light receiver 12b, and is used for measuring the image density of the toner image formed on the photosensitive drum 1. The reflected light amount sensor 12 irradiates the toner image on the photosensitive drum 1 with light from the light emitter 12a. The light receiver 12b receives reflected light reflected by the toner image, and outputs an output signal corresponding to the received reflected light amount.

The primary transfer roller 7 presses an inner surface of the intermediate transfer belt 6 to form a primary transfer portion T1 between the photosensitive drum 1 and the intermediate transfer belt 6. Through application of a DC voltage having a positive polarity to the primary transfer roller 7, a toner image having a negative polarity borne on the photosensitive drum 1 is transferred onto the intermediate transfer belt 6 passing through the primary transfer portion T1. In the manner described above, the image forming unit P forms a toner image of a corresponding color on the photosensitive drum 1. The toner image is transferred from the photosensitive drum 1 onto the intermediate transfer belt 6. The drum cleaner 8 rubs a cleaning blade against the photosensitive drum 1 to collect the transfer residual toner remaining on the photosensitive drum 1 after the transfer onto the intermediate transfer belt 6.

The operation of such an image forming unit P is controlled by the printer controller 109 and the controller 110 provided in the printer B. The printer controller 109 controls the operation of the printer B. The controller 110 controls the operation of the entire image forming apparatus 100. The controller 110 is connected to the printer controller 109 and the image processor 108 of the reader A. Further, the operation unit 20 is connected to the controller 110. The operation unit 20 is also connected to the CPU 214 of the reader A. Although not shown, the controller 110 is also connected to the CPU 214 of the reader A.

The controller 110 includes the CPU 111, a RAM 112, and a ROM 113. The CPU 111 executes a computer program stored in the ROM 113 to control the operation of the image forming apparatus 100. The RAM 112 is a work memory used when the CPU 111 executes the processing. Various operations of the reader A and the printer B of the image forming apparatus 100 are controlled by the CPU 111. The printer controller 109 includes a light amount controller 190, a pattern generator 192, and a pulse width modulator 191. The image processor 108 includes a video counter 220 and a γ corrector 209.

The exposing device 3 in the first embodiment is a laser scanner including a rotary mirror. The exposing device 3 determines an exposure amount by the light amount controller 190 in order to obtain a predetermined image density level with respect to a laser output signal. In the first embodiment, in order to suppress the image density unevenness in the main scanning direction and the sub-scanning direction, exposure amount setting (LPW) is managed by allowing the exposure amount to be set in the unit of the width of about 30 mm in each direction. Further, the exposing device 3 controls on and off states of laser light in accordance with a pulse width determined by the pulse width modulator 191 based on a drive signal generated through use of a tone correction table (LUT) of the γ corrector 209.

The laser output signal is determined based on the tone correction table held by the γ corrector 209. The tone correction table represents a relationship between the laser output signal and the image density level of the image to be formed, and the laser output signal is determined depending on the image density of the image to be formed.

The printer controller 109 acquires the image signal generated by the image processor 108. The printer controller 109 subjects the laser light output from the light source of the exposing device 3 based on the image signal to pulse width modulation (PWM) to form an image having an image density tone based on area coverage modulation. Accordingly, the printer controller 109 generates and outputs, by the pulse width modulator 191, a laser output signal having a width (time width) corresponding to the level of the image signal of each pixel. The laser output signal is a laser drive pulse signal. For an image signal specifying a high image density, the laser output signal becomes a pulse signal having a wide width. For an image signal specifying a low image density, the laser output signal becomes a pulse signal having a narrow width. For an image signal specifying an intermediate image density, the laser output signal becomes a pulse signal having an intermediate width.

The laser output signal (laser drive pulse signal) output from the pulse width modulator 191 is supplied to a light source (for example, a semiconductor laser) of the laser light of the exposing device 3. The semiconductor laser outputs the laser light for a time period corresponding to the pulse width of the laser output signal. Accordingly, the semiconductor laser is driven for a long time period for a pixel having a high image density, and is driven for a short time period for a pixel having a low image density. Thus, the dot size (area) of the electrostatic latent image formed on the photosensitive drum 1 varies depending on the image density of the pixel. The exposing device 3 performs exposure in a range longer in the main scanning direction for the pixel having a high image density, and performs exposure in a range shorter in the main scanning direction for the pixel having a low image density.

The pattern generator 192 generates an image signal of a pattern image formed to correct the image forming condition. In this case, examples of the image forming condition include a light amount (exposure amount) of light emitted from the light source of the exposing device 3, a charging bias voltage to be applied to the charging device 2, and a developing bias voltage to be applied to the developing device 4. The image forming condition may be any one of the exposure amount, the charging bias voltage, and the developing bias voltage, or may be two or all three of the exposure amount, the charging bias voltage, and the developing bias voltage. In a case where a pattern image for correcting the density unevenness in the sub-scanning direction is to be formed, the pulse width modulator 191 generates a laser output signal based on an image signal of the pattern image acquired from the pattern generator 192.

The printer controller 109 may acquire an image signal not only from the reader A but also from an external device. For example, the printer controller 109 may acquire an image signal by a receiver (not shown) via a telephone line. Further, the printer controller 109 may acquire an image signal via a network (not shown). The printer controller 109 performs processing as described above even on the image signal acquired by any route. The image forming apparatus 100 functions as a copying machine in a case where an image is printed based on the image signal acquired from the reader A. The image forming apparatus 100 functions as a fax machine in a case where an image is printed based on the image signal acquired via the telephone line. The image forming apparatus 100 functions as a printer in a case where an image is printed based on the image signal acquired via the network.

### <Shading Function>

In the first embodiment, the correction of the image density unevenness in the sub-scanning direction is performed through use of a shading function included in the exposing device 3. The light amount controller 190 acquires, from the ROM 113 of the controller 110, a correction value of an exposure amount corresponding to each exposure position and a phase in the sub-scanning direction, and controls the exposure by means of exposure amount setting (LPW) that is based on this correction value. The correction value of the exposure amount corresponding to each exposure position is obtained through image density unevenness correction to be described later. In the first embodiment, the ROM 113 stores correction values for the exposure amount setting at an interval of about 10 mm in the main scanning direction and at an interval of about 30 mm in the sub-scanning direction. The image density unevenness in the main scanning direction is handled by shading correction in the main scanning direction. In the shading correction in the main scanning direction, the light amount controller 190 acquires, from the ROM 113 of the controller 110, the correction value of the light amount corresponding to each exposure position in the main scanning direction, and controls the exposure by means of the light amount setting that is based on this correction value.

### <Image Density Unevenness Correction>

In the following, image density unevenness correction processing for suppressing image density unevenness in the sub-scanning direction is described. The controller 110 performs, in the image density unevenness correction processing, for example, exposure amount correction processing of the exposing device 3 at the time of image formation, pattern image formation processing for detecting the image density unevenness, image density unevenness detection processing, and image density correction calculation processing.

In the first embodiment, the image density sensor 69 is used as a reading sensor to be used in the image density unevenness detection processing. The image density sensor 69 reads, through use of a direction intersecting with a conveying direction of the sheet S conveyed through the conveyance path 70 as one line, a pattern image (measurement image) printed on the sheet S. The image density sensor 69 can read the sheet S being conveyed to measure a luminance value of the entire sheet S.

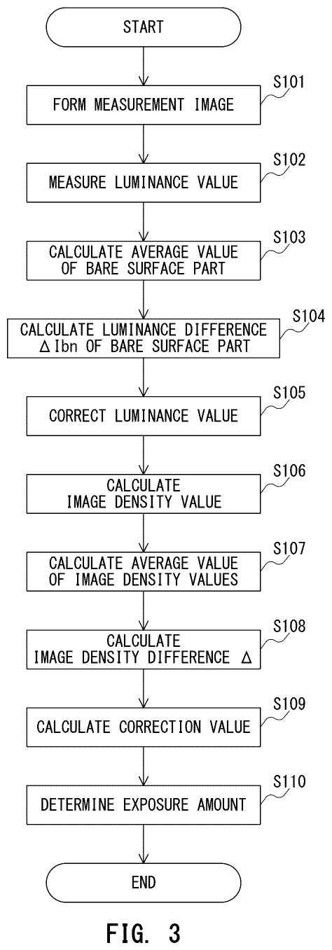

FIG. 3 is a flow chart for illustrating processing of correcting image density unevenness in the sub-scanning direction. The image density unevenness in the sub-scanning direction is caused by eccentricity of a rotary member involved in image formation, such as the photosensitive drum 1, the developing sleeve 41, or the primary transfer roller 7, in accordance with a rotation period of the rotary member. In the processing of correcting the image density unevenness in the sub-scanning direction, the image density unevenness in the sub-scanning direction is corrected by correcting the image forming condition in accordance with such a period of the rotary member. Description is given here of a case in which the image density unevenness in the sub-scanning direction caused by the photosensitive drum 1 is corrected.

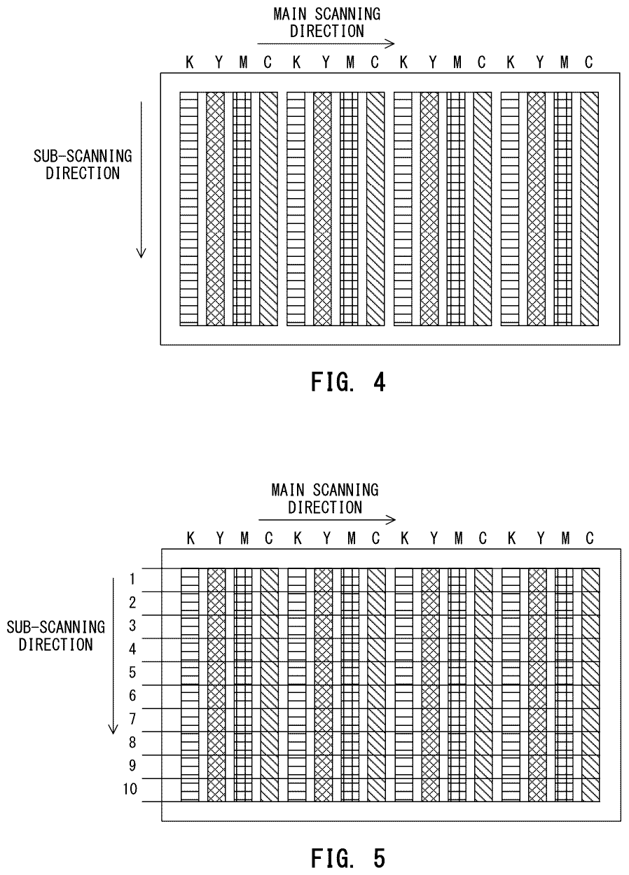

In a case where the controller 110 starts the processing of correcting the image density unevenness in the sub-scanning direction, the controller 110 forms a pattern image (sub-scanning measurement image) for correcting the image density unevenness in the sub-scanning direction on the sheet S (Step S101). FIG. 4 is an exemplary view of the sub-scanning measurement image. The sub-scanning measurement image is a band image having a predetermined width in the main scanning direction and extending to have a predetermined length in the sub-scanning direction. The sub-scanning measurement image is formed based on an image signal indicating a uniform image density. This image signal is generated by the pattern generator 192. The band images (pattern images) of the respective colors (Y, M, C, and K) are arranged at a predetermined interval in the main scanning direction. In the first embodiment, the pattern image of each color is formed based on an image signal indicating the image density of 40%.

As for the image forming condition in the sub-scanning direction, it is required to associate the position of the sub-scanning measurement image (pattern image) and the rotation phase of the rotary member (the photosensitive drum 1) that is the cause of the image density unevenness with each other. In the first embodiment, phase control of the photosensitive drum 1 is performed so that a write start position of the pattern image and a home position of the rotation phase are controlled to match each other. In this manner, the controller 110 can obtain image density unevenness information representing image density unevenness accurately corresponding to the phase for one rotation of the photosensitive drum 1 of each color.

FIG. 5 is an explanatory view for illustrating a detection position of the sub-scanning measurement image. In FIG. 5, the length of about 300 mm corresponding to an amount equal to or more than one period of the photosensitive drum 1 is equally divided into ten parts, and the pattern image is detected in units divided into 1 to 10 at about every 30 mm from the upstream side of the conveying direction (sub-scanning direction).

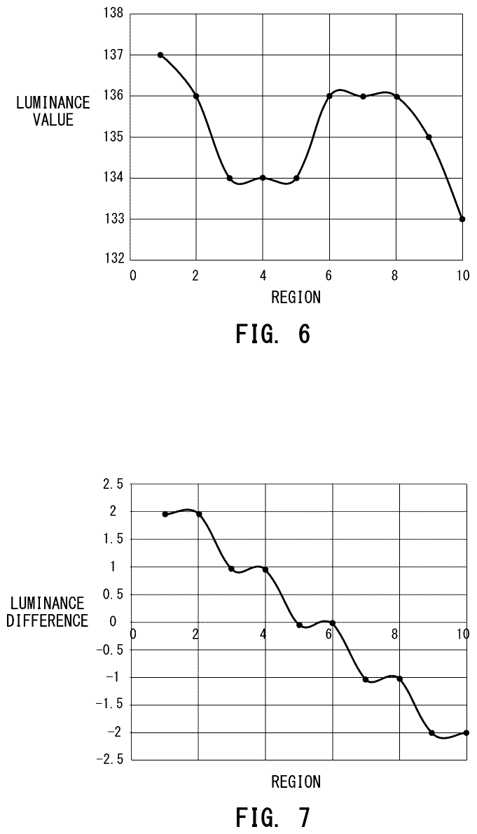

The controller 110 controls the image density sensor 69 to read the sheet S having the sub-scanning measurement image printed thereon, and detects a luminance value as a reading result (Step S102). The controller 110 detects a luminance value I of the sub-scanning measurement image in each divided unit based on the reading result of the sub-scanning measurement image obtained by the image density sensor 69. Further, the controller 110 detects a luminance value Ib of a bare surface part of the sheet S in each divided unit based on a reading result obtained by the image density sensor 69 of a region (bare surface part) of the sheet S in which no pattern image is formed between the pattern images of the respective colors in which no sub-scanning measurement image is printed. FIG. 6 is an exemplary graph for showing the luminance value I of a magenta pattern image. As shown in FIG. 6, the luminance value I in each divided unit (each region) is detected.

The controller 110 calculates an average value Ibave of luminance values Ibn (n=1 to 10) of respective divided units (respective regions) of the bare surface part (Step S103). The controller 110 calculates a difference (luminance difference ΔIbn) of the luminance value Ibn of the bare surface part of each region from the calculated average value Ibave (Step S104). (Expression 1) is a calculation expression of the luminance difference ΔIbn. FIG. 7 is an exemplary graph for showing the luminance difference ΔIbn of the bare surface part.

$$Δ Ibn = Ibn - Ibave \qquad ( Expression 1 )$$

(n: 1 to 10)

In the pattern image of FIG. 4, the pattern images of the respective colors are arranged side by side in the main scanning direction at a predetermined interval, and hence a plurality of luminance values are detected in the same region in the sub-scanning direction. For example, in a region 1 (see FIG. 5) in the sub-scanning direction, fifteen luminance values are detected from parts between the pattern images of the respective colors. In this case, as the luminance value Ibn, for example, any value such as an average value, a median, a maximum value, or a minimum value of the plurality of luminance values detected in the same region in the sub-scanning direction is used. In a case where the pattern image is an image from which only one bare surface part can be detected, the one luminance value is directly used as the luminance value Ibn. For example, in a case where the pattern images of the respective colors are arranged side by side in the main scanning direction without any interval therebetween and only one bare surface part is provided between any pattern images in the main scanning direction, the controller 110 can detect only one bare surface part.

In a case where the luminance value of the sub-scanning measurement image is detected from the sheet S being conveyed, the sheet S flutters during conveyance, resulting in fluctuations in distance between the image density sensor 69 and the sheet S. The fluctuations in distance between the image density sensor 69 and a measurement target cause changes in output value (luminance value) of the image density sensor 69. Accordingly, luminance unevenness is caused in the luminance value detected by the image density sensor 69. The luminance value obtained from the sub-scanning measurement image also includes the image density unevenness of the sub-scanning measurement image. The luminance value detected as described above includes a sensing error of the image density sensor 69 and the image density unevenness.

The luminance difference ΔIbn between the luminance value Ibn of each region and the average value Ibave of the bare surface part of the sheet S only extracts the luminance unevenness caused by a change in sensing error of the image density sensor 69 due to the fluttering of the sheet S. The sensing error due to the fluttering of the sheet S has a substantially similar tendency in the main scanning direction. The controller 110 corrects the luminance value I obtained from the reading result of the pattern image of each color with the luminance difference ΔIbn obtained from the reading result of the bare surface part, to thereby remove the influence of the sensing error caused by the fluttering of the sheet S from the luminance value I (Step S105). Through the correction using the luminance difference ΔIbn, only the image density unevenness of the pattern image of each color is extracted. The correction using the luminance difference ΔIbn of the luminance value I of each region is performed through use of, for example, (Expression 2).

$$Corrected luminance value {I}^{′} n = “ Luminance value In ” - “ Luminance difference Δ Ibn ” \qquad ( Expression 2 )$$

(n: 1 to 10)

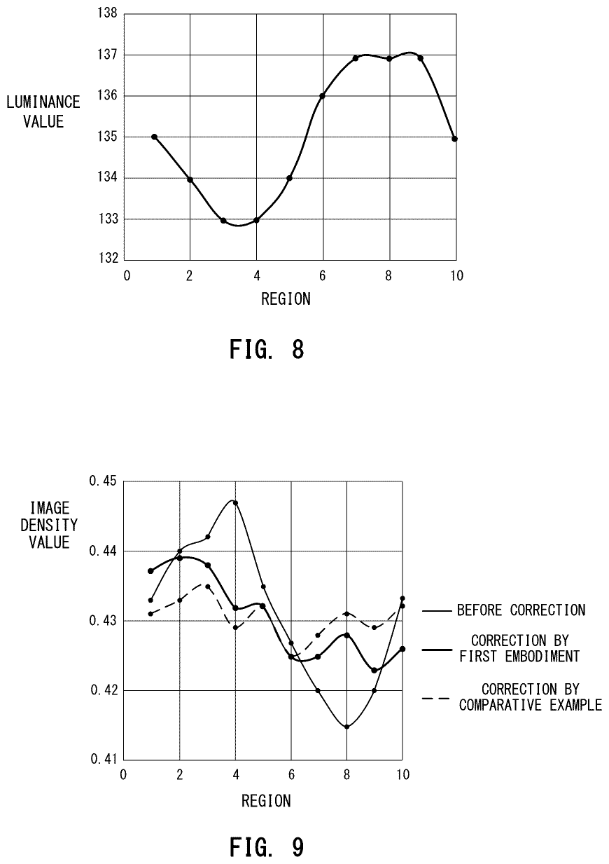

FIG. 8 is an exemplary graph for showing a corrected luminance value I′n of each region, which is obtained by correcting the luminance value In of each region detected from the magenta pattern image with the luminance difference ΔIbn. FIG. 8 shows a result of correcting the luminance value of FIG. 6 with the luminance difference of FIG. 7. The corrected luminance value I′n of FIG. 8 is the image density unevenness of the sub-scanning measurement image that is originally a target of correction.

The controller 110 converts the corrected luminance value I′n of each region into an image density value (Step S106). The controller 110 converts the corrected luminance value I′n into the image density value through use of, for example, a conversion table or a conversion expression. The controller 110 calculates an average value of ten image density values of the respective regions (Step S107). The controller 110 calculates an image density difference Δ between the average value of the image density values and the image density value of each of the regions (Step S108). The controller 110 calculates a correction value (ΔLPW) corresponding to the calculated image density difference Δ (Step S109). The controller 110 determines the exposure amount of each region based on the calculated correction value (ΔLPW) (Step S110).

The above-mentioned image density unevenness correction processing is performed for each pattern image of each color formed at each position in the main scanning direction. In this manner, the exposure amount for forming an image of each color to correspond to each position in the main scanning direction is determined. The controller 110 performs image formation in an exposure amount determined in a combination of the position in the main scanning direction and the rotation phase, to thereby suppress the image density unevenness.

An effect of suppressing the image density unevenness by the image density unevenness correction processing as described above is described. The sub-scanning measurement image for verifying the effect is an image exemplified in FIG. 4. The reading position is the position exemplified in FIG. 5. Under such a condition, the effect was verified by causing the image density sensor 69 to detect the image density of the sub-scanning measurement image printed on the sheet S.

FIG. 9 is an exemplary graph for showing the image density value obtained from the magenta pattern image through the verification. FIG. 9 exemplifies an image density value (thin line) before the image density unevenness correction processing, an image density value (thick line) after the image density unevenness correction processing, and an image density value (dotted line) in a case in which the image density unevenness correction processing is performed without performing correction using the luminance value of the bare surface part. As indices indicating the image density unevenness, a maximum image density value, a minimum image density value, and a differential image density value are shown.

The image density value before the image density unevenness correction processing is the following image density unevenness.

$$Maximum image density value Dmax = 0.447$$

$$Minimum image density value Dmin = 0.415$$

$$Differential image density value Δ D = 0.032$$

The image density value after the image density unevenness correction processing is the following image density unevenness. The image density value after the image density unevenness correction processing is smaller in the differential image density value AD than the image density value before the image density unevenness correction processing.

$$Maximum image density value Dmax = 0.435$$

$$Minimum image density value Dmin = 0.425$$

$$Differential image density value Δ D = 0.01$$

The image density value in the case in which the correction using the luminance value of the bare surface part is not performed is the following image density unevenness. The image density value in this case varies in the degree of correction in each region, resulting in that the effect of the image density unevenness correction processing is reduced.

$$Maximum image density value Dmax = 0.439$$

$$Minimum image density value Dmin = 0.423$$

$$Differential image density value Δ D = 0.016$$

As described above, in the image forming apparatus 100 according to the first embodiment, the influence of the image density unevenness caused by the image density sensor 69 can be reduced, and the image density unevenness in the sub-scanning direction can be accurately detected. Thus, the exposure amount can be determined based on an optimum correction value, and a high-quality image with suppressed image density unevenness can be formed. Such highly-accurate image density unevenness correction is achieved.

### Second Embodiment

In the first embodiment, description has been given of a technology of correcting the image density unevenness in the sub-scanning direction. In a second embodiment of the present disclosure, description is given of a technology of correcting the image density unevenness in the main scanning direction. The configuration of the image forming apparatus 100 is similar to that in the first embodiment, and hence description thereof is omitted. In the second embodiment, the pattern image is read not by the image density sensor 69 but by the reader A.

As described above, the reader A optically reads the original G placed on the platen 102 to read lines of an image on the entire area of the original G one after another. The reader A generates an image signal including a data column of each line as a reading result. The image signal is subjected to image processing by the image processor 108 to be transmitted to the printer controller 109 of the printer B. The printer controller 109 performs predetermined image processing on the acquired image signal.

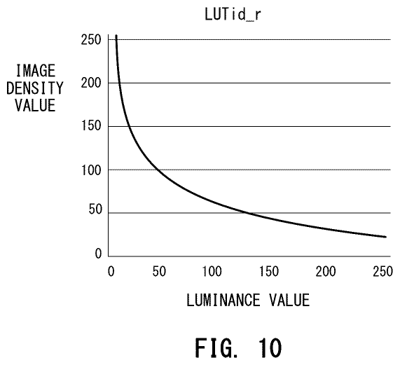

The reader A reads the original G to detect the luminance value. The luminance value is converted into the image density value by the image processor 108. FIG. 10 is an exemplary graph for showing a luminance-density conversion table for converting the luminance value into the image density value. In this luminance-density conversion table LUTid_r, the luminance value is converted into an 8-bit image density value. The image density value obtained by conversion is transmitted to the printer controller 109.

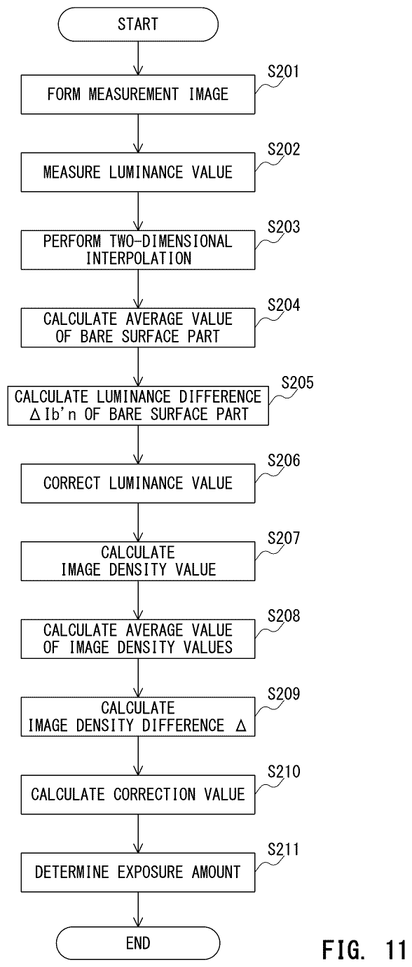

FIG. 11 is a flow chart for illustrating processing of correcting the image density unevenness in the main scanning direction. The controller 110 performs, for example, exposure amount correction processing of the exposing device 3 at the time of image formation, pattern image formation processing for detecting the image density unevenness, image density unevenness detection processing, correction processing using a detection result of the bare surface part of the sheet S, and image density correction calculation processing.

When the controller 110 starts the processing of correcting the image density unevenness in the main scanning direction, the controller 110 forms a pattern image (main scanning measurement image) for correcting the image density unevenness in the main scanning direction on the sheet S (Step S201). FIG. 12 is an exemplary view of the main scanning measurement image. The main scanning measurement image is a band image having a predetermined width in the sub-scanning direction and extending to have a predetermined length in the main scanning direction. The main scanning measurement image is formed based on an image signal indicating a uniform image density. This image signal is generated by the pattern generator 192. The band images (pattern images) of the respective colors (Y, M, C, and K) are arranged in the sub-scanning direction. In the second embodiment, the pattern image of each color is formed based on an image signal indicating the image density of 40%.

In order to alleviate the influence of the image density unevenness in the sub-scanning direction, the band images of the respective colors are arranged at two different locations in the sub-scanning direction. In FIG. 12, a band image on the upstream side in the sub-scanning direction is referred to as “first band image,” and a band image on the downstream side in the sub-scanning direction is referred to as “second band image.” A first bare surface part is provided on the upstream side in the sub-scanning direction with respect to the first band image. A second bare surface part is provided between the first band image and the second band image. A third bare surface part is provided on the downstream side in the sub-scanning direction with respect to the second band image.

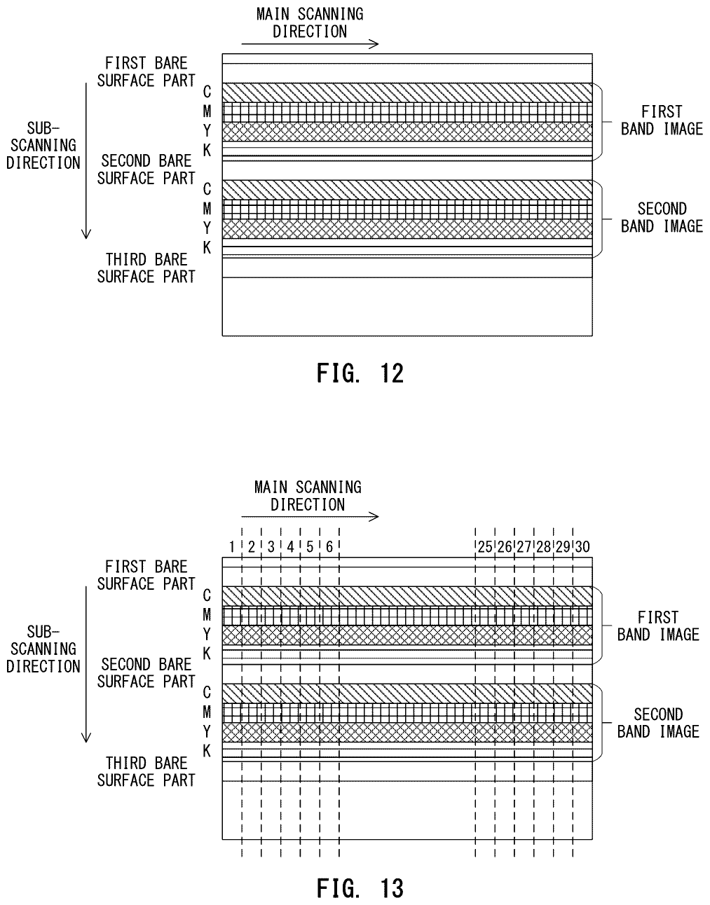

FIG. 13 is an explanatory view for illustrating a detection position of the main-scanning measurement image. In FIG. 13, the band image extending in the main scanning direction is equally divided into thirty parts at a width of 30 mm in the main scanning direction, and the main-scanning measurement image is detected in units divided into 1 to 30 from the upstream side in the main scanning direction.

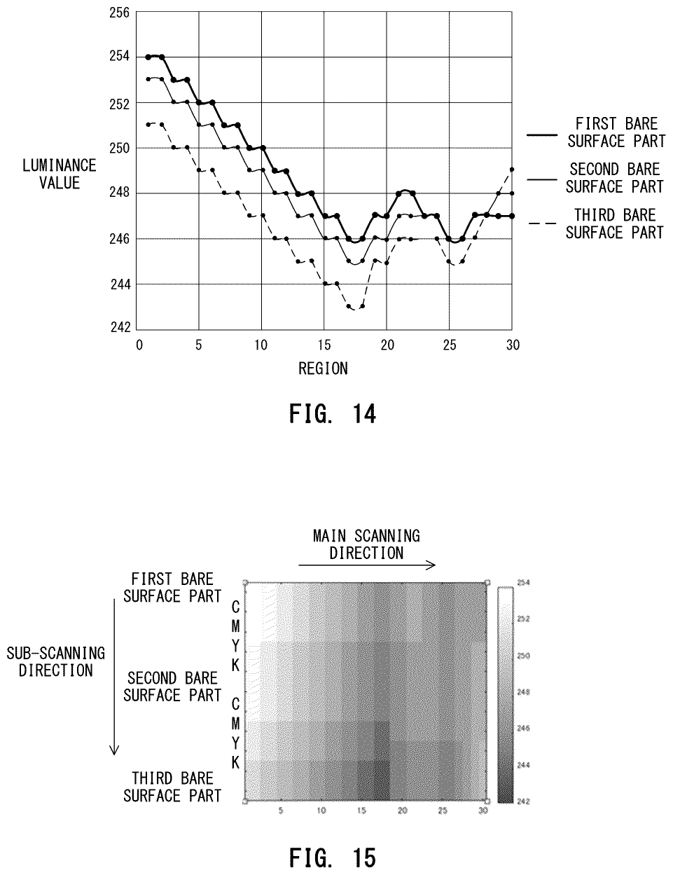

A user places the sheet S having the main-scanning measurement image formed thereon on the platen 102 and gives an instruction to read the main-scanning measurement image through the operation unit 20. The controller 110 controls the reader A to read the sheet S having the main-scanning measurement image printed thereon in accordance with the instruction and detect the luminance value as the reading result (Step S202). The reader A detects the luminance value I of the main-scanning measurement image in each divided unit based on the reading result of the main-scanning measurement image. Further, the reader A detects the luminance value Ib of each of the first to third bare surface parts of the sheets S in each divided unit based on the reading result of each of the first to third bare surface parts in which no main-scanning measurement image is printed. FIG. 14 is an exemplary graph for showing the luminance values Ib of the first to third bare surface parts. As shown in FIG. 14, the luminance value Ib in each divided unit (each region) is detected.

The controller 110 controls the image processor 108 of the reader A to generate a luminance value Ib′ obtained through two-dimensional linear interpolation of the luminance values Ibn (n=1 to 30) of respective divided units (respective regions) of the first to third bare surface parts (Step S203). FIG. 15 is an exemplary diagram for showing the luminance value Ib′. Through linear interpolation, the luminance values of the bare surface parts in the main scanning direction and the sub-scanning direction are calculated. The controller 110 controls the image processor 108 of the reader A to calculate an average value Ib′ave of luminance values Ib′n at respective positions in the sub-scanning direction from the result of the two-dimensional linear interpolation of the bare surface parts (Step S204). The controller 110 controls the image processor 108 to calculate a difference (luminance difference ΔIb′n) of the luminance value Ibn of the bare surface part of each region from the calculated average value Ib′ave (Step S205). (Expression 3) is a calculation expression of the luminance difference ΔIb′n.

$$Luminance difference Δ {Ib}^{′} n = {Ib}^{′} n - Ibave \qquad ( Expression 3 )$$

(n: 1 to 30)

The controller 110 controls the image processor 108 to correct a luminance value In of each region of the first band image and the second band image of each color with the luminance difference ΔIb′n of the each region (Step S206). In the second embodiment, correction is performed through use of a coefficient “a” obtained by experimentally acquiring in advance a relationship between a luminance difference in a case of detecting the first to third bare surface parts and a luminance difference in a case of detecting a pattern image having an image density of 40% of each color. (Expression 4) is a calculation expression of the correction. FIG. 16 is an exemplary table for showing the coefficient “a”. The coefficient “a” is set for each color.

$$Corrected luminance value {I}^{′} n = “ Luminance value In - a ” \times “ Luminance difference Δ {Ib}^{′} n ” \qquad ( Expression 4 )$$

(n: 1 to 30)

The controller 110 controls the image processor 108 to convert the corrected luminance value I′n of each region into the image density value (Step S207). The image processor 108 converts the corrected luminance value I′n into the image density value through use of, for example, the luminance-density conversion table LUTid_r of FIG. 10 or a conversion expression. The controller 110 acquires thirty image density values of the respective regions from the image processor 108, and calculates an average value of the thirty image density values (Step S208). The controller 110 calculates an image density difference Δ between the average value of the image density values and the image density value of each of the regions (Step S209).

The controller 110 averages the image density differences A respectively calculated from the first band image and the second band image. With the image density differences A of the respective regions of the two band images separated from each other in the sub-scanning direction being averaged, the influence of the image density unevenness in the rotation direction (sub-scanning direction) of the rotary member can be suppressed. The controller 110 calculates a correction value (ΔLPW) corresponding to the averaged image density difference Δ (Step S210). The controller 110 determines the exposure amount of each region based on the calculated correction value (ΔLPW) (Step S211).

An effect of suppressing the image density unevenness by the image density unevenness correction processing as described above is described. The measurement image for verifying the effect is an image exemplified in FIG. 12. The reading position is the position exemplified in FIG. 13. Under such a condition, the effect was verified by causing the reader A to detect the image density of the measurement image printed on the sheet S.

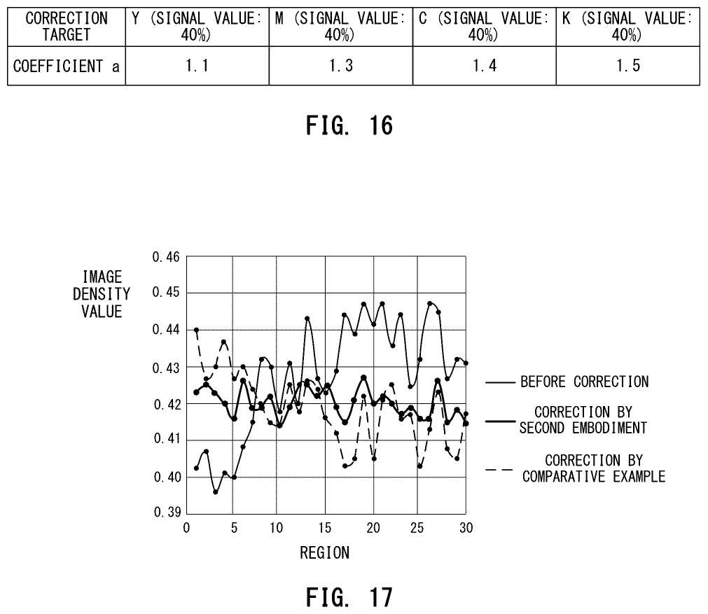

FIG. 17 is an exemplary graph for showing the image density value obtained from the magenta pattern image through the verification. The image density value of FIG. 17 is an average value of the image density values of the first band image and the second band image of magenta. FIG. 17 exemplifies an image density value (thin line) before the image density unevenness correction processing, an image density value (thick line) after the image density unevenness correction processing, and an image density value (dotted line) in a case in which the image density unevenness correction processing is performed without performing correction using the luminance value of the bare surface part. As indices indicating the image density unevenness, a maximum image density value, a minimum image density value, and a differential image density value are shown.

The image density value before the image density unevenness correction processing is the following image density unevenness.

$$Maximum image density value Dmax = 0.447$$

$$Minimum image density value Dmin = 0.396$$

$$Differential image density value Δ D = 0.051$$

The image density value after the image density unevenness correction processing is the following image density unevenness. The image density value after the image density unevenness correction processing is smaller in the differential image density value AD than the image density value before the image density unevenness correction processing.

$$Maximum image density value Dmax = 0.427$$

$$Minimum image density value Dmin = 0.414$$

$$Differential image density value Δ D = 0.013$$

The image density value in the case in which the correction using the luminance value of the bare surface part is not performed is the following image density unevenness. The image density value in this case varies in the degree of correction in each region, resulting in that the effect of the image density unevenness correction processing is reduced.

$$Maximum image density value Dmax = 0.44$$

$$Minimum image density value Dmin = 0.403$$

$$Differential image density value Δ D = 0.037$$

As described above, in the image forming apparatus 100 according to the second embodiment, the influence of the image density unevenness caused by the image density sensor 69 can be reduced, and the image density unevenness in the main scanning direction can be accurately detected. Thus, the exposure amount can be determined based on an optimum correction value, and a high-quality image with suppressed image density unevenness can be formed. Such highly-accurate image density unevenness correction is achieved.

In the description above, the image density unevenness is detected in the sub-scanning direction in the first embodiment and in the main scanning direction in the second embodiment, but the embodiments are applicable also when the image density unevenness in the main scanning direction and the image density unevenness in the sub-scanning direction are simultaneously detected. In this case, similarly to the second embodiment, two-dimensional interpolation data is created based on detection results of a plurality of paper bare surface parts to correct the detection result of the measurement image.

In the first embodiment and the second embodiment, the image forming apparatus 100 is configured to form a color image, but the processing in the first embodiment and the second embodiment is effective even when the image forming apparatus is configured to form a monochrome image.

According to the present disclosure as described above, it is possible to correct the image density unevenness with high accuracy.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-134358, filed Aug. 9, 2024, which is hereby incorporated by reference herein in its entirety.

What is claimed is:

1. An image forming apparatus comprising:
an image former configured to form an image on a sheet;
a conveyance path through which a sheet having a pattern image formed thereon by the image former is to be conveyed;
a reading sensor configured to read the sheet having the pattern image formed thereon during conveyance of the sheet through the conveyance path; and
a controller configured to suppress image density unevenness in a conveying direction of an image to be formed by the image former,
wherein the image density unevenness is suppressed based on a reading result of the pattern image read by the reading sensor and a reading result obtained by reading, by the reading sensor, a plurality of positions in the conveying direction of the sheet conveyed through the conveyance path in a region in which the pattern image is not formed in the sheet having the pattern image formed thereon.

2. The image forming apparatus according to claim 1,
wherein the reading sensor is configured to read the pattern image and the region at a plurality of positions in the conveying direction, and
wherein the controller is configured to correct a reading result of the pattern image at a corresponding position with the reading result of the region at each of the plurality of positions, and suppress the image density unevenness based on a corrected reading result of the pattern image.

3. The image forming apparatus according to claim 2, wherein the controller is configured to correct, based on a difference between an average value of reading results of the region at the plurality of positions in the conveying direction and a reading result of the region at each position, a reading result of the pattern image at the each position, and suppress the image density unevenness based on the corrected reading result of the pattern image.

4. The image forming apparatus according to claim 1,
wherein the reading result of the region and the reading result of the pattern image are each a luminance value, and
wherein the controller is configured to correct the luminance value of the pattern image with the luminance value of the region, convert the corrected luminance value of the pattern image into an image density value, and suppress the image density unevenness based on the image density value.

5. The image forming apparatus according to claim 1,
wherein the reading result of the region and the reading result of the pattern image are each a luminance value,
wherein the controller is configured to correct, based on a difference between an average value of luminance values of the region at a plurality of positions in the conveying direction and a luminance value of the region at each position, the luminance value of the pattern image at the each position, and
wherein the controller is configured to convert a corrected luminance value of the pattern image at each position into an image density value, and suppress the image density unevenness based on a difference between an average value of image density values at respective positions and an image density value at each position.

6. The image forming apparatus according to claim 3, wherein the pattern image is a plurality of band images extending in the conveying direction and being arranged side by side in a direction intersecting with the conveying direction, and the region is provided between the plurality of band images.

7. The image forming apparatus according to claim 1, wherein the image former includes a rotary member for use in forming an image.

8. The image forming apparatus according to claim 2, wherein the controller is configured to correct, based on a difference between an average value of reading results of the region at respective positions in the conveying direction, which are obtained as a result of two-dimensional linear interpolation of reading results of the region at a plurality of positions in a direction intersecting with the conveying direction, and a reading result of the region at each position, a reading result of the pattern image at the each position, and suppress the image density unevenness based on a corrected reading result of the pattern image.

9. The image forming apparatus according to claim 8,
wherein the reading result of the region and the reading result of the pattern image are each a luminance value,
wherein the controller is configured to correct, based on a difference between an average value of luminance values of the region at respective positions in the conveying direction, which are obtained as a result of two-dimensional linear interpolation of luminance values of the region at a plurality of positions in the direction intersecting with the conveying direction, and a luminance value of the region at each position, a luminance value of the pattern image at the each position, and
wherein the controller is configured to convert a corrected luminance value of the pattern image at each position into an image density value, and suppress the image density unevenness based on a difference between an average value of image density values at respective positions and an image density value at each position.

10. The image forming apparatus according to claim 8,
wherein the image former includes a rotary member for use in forming an image, and
wherein the conveying direction is a rotation direction of the rotary member.

11. The image forming apparatus according to claim 8,
wherein the pattern image is a plurality of band images extending in the direction intersecting with the conveying direction and being arranged side by side in the conveying direction, and
wherein the region is provided between the plurality of band images, on an upstream side in the conveying direction of the plurality of band images, and on a downstream side in the conveying direction of the plurality of band images.

12. The image forming apparatus according to claim 1,
wherein the image former includes a photosensitive member configured to rotate, and
wherein the image former is configured to form an image on the photosensitive member and transfer the image formed on the photosensitive member onto the sheet.

13. The image forming apparatus according to claim 1,
wherein the image former includes a developing sleeve configured to carry a developer and rotate, and
wherein the image former is configured to develop an electrostatic latent image formed on a photosensitive member through use of the developer carried on the developing sleeve.

14. The image forming apparatus according to claim 1,
wherein the image former includes a transfer roller configured to rotate, and
wherein the image former is configured to form an image on a photosensitive member and transfer the image formed on the photosensitive member onto the sheet by applying a voltage to the transfer roller.

15. An image forming apparatus comprising:
an image former configured to form an image on a sheet;
a conveyance path through which a sheet having a pattern image formed thereon by the image former is to be conveyed;
a reading sensor configured to read the sheet having the pattern image formed thereon during conveyance of the sheet through the conveyance path; and
a controller configured to suppress image density unevenness in a conveying direction of an image to be formed by the image former, wherein the image density unevenness is suppressed based on a result of the pattern image read by the reading sensor and a reading result obtained by reading, by the reading sensor, a plurality of positions in the conveying direction of the sheet conveyed through the conveyance path in a region in which the pattern image is not formed in the sheet having the pattern image formed thereon,
wherein the controller is configured to correct, based on a difference between an average value of reading results of the region at respective positions in the conveying direction, which are obtained as a result of two-dimensional linear interpolation of reading results of the region at a plurality of positions in the conveying direction, and a reading result of the region at each position, a reading result of the pattern image at the each position, and suppress the image density unevenness in the conveying direction and in a direction intersecting with the conveying direction based on a corrected reading result of the pattern image.

16. A method of controlling an image forming apparatus,
the image forming apparatus including:
an image former configured to form an image on a sheet;
a conveyance path through which a sheet having a pattern image formed thereon by the image former is to be conveyed; and
a reading sensor configured to read the sheet having the pattern image formed thereon during conveyance of the sheet through the conveyance path;
the method comprising suppressing, based on a reading result of the pattern image read by the reading sensor and a reading result obtained by reading, by the reading sensor, a plurality of positions in a conveying direction of the sheet conveyed through the conveyance path in a region in which the pattern image is not formed in the sheet having the pattern image formed thereon, image density unevenness in the conveying direction of an image to be formed by the image former.
